(19) United States
(12) Patent Application Publication
(10) Pub. No.: US 2015/0068333 A1
(43) Pub. Date: Mar. 12, 2015

(54) TRANSMISSION STRUCTURE OF A FILLING MACHINE

(71) Applicant: Kun-Nan Yang, Taichung City (TW)

(72) Inventor: Kun-Nan Yang, Taichung City (TW)

(21) Appl. No.: 14/023,454

(22) Filed: Sep. 10, 2013

(51) Int. Cl. F16H 21/50

(52) U.S. Cl. CPC F16H 21/50
USPC 74/45

(57) ABSTRACT

A transmission structure, which is connected to a motor of a filling machine so as to drive a transmission operation of the filling machine, includes a transmitting wheel, a swing set, a clamper, a lift set, a supporting plate and a transmitting set. Under this arrangement, the swing set, the lift set and the transmitting set cooperate with each other via only the transmitting wheel, rather than cooperate with each other via a plurality of members corresponding to different sets as the prior art. Therefore, the structure of the present invention is simpler than that of the prior art; a weight or a volume of the present invention is littler than that of the prior art. In addition, the present invention is easier to maintain than the prior art, because the structure of the present invention is simpler than that of the prior art.

### BACKGROUND OF THE INVENTION

1. Field of the Invention

The present invention relates to a transmission structure, and more particularly to a transmission structure of a filling machine.

2. Description of Related Art

FIG. 1 to FIG. 4-8 of patent TWM353639 disclose a conventional transmission structure of a filling machine, wherein the FIG. 1 to FIG. 4-8 of the patent TWM353639 are arranged as an IDS (Information Disclosure Statement) of the present invention. Referring to FIG. 1 to FIG. 4-8 of the patent TWM353639, the conventional transmission structure of a filling machine comprises a motor, a transmitting chain, a first gear and a second gear which cooperate with each other. The transmitting chain is engaged with the first gear and the second gear. The motor drives the first gear and the second gear to rotate. The transmitting chain is operated by said rotation of each gear.

However, the conventional transmission structure has two disadvantages as following:

First, it needs two gears to operate the transmitting chain so that the structure is too complicated to be easily maintained; in addition, the two gears occupies much space so that the conventional transmission structure might be bulky.

Second, the chain might be unexpectedly disengaged from the two gears during operation, because of the engagement design of the conventional transmission structure.

The present invention has arisen to mitigate and/or obviate the disadvantages of the conventional braking system.

### SUMMARY OF THE INVENTION

The main objective of the present invention is to provide an improved transmission structure.

To achieve the objective, a transmission structure, which is connected to a motor of a filling machine so as to drive a transmission operation of the filling machine, comprises a transmitting wheel having a shaft member extended from one side thereof, the shaft member connected to the motor, the transmitting wheel having a first rail defined at one side thereof, the first rail encircling the shaft member, the transmitting wheel having a second rail defined around a center of another side thereof, the transmitting wheel having a third rail defined at another side thereof, the third rail located along an outer periphery of the second rail, the third rail having two ends which both communicate with an outside relative to the transmitting wheel; a swing set assembled to the transmitting wheel, the swing set having two latitudinal rods, two longitudinal rods and a first spindle, each latitudinal rod connected to the two longitudinal rods at two ends thereof, so as to define an assembling area which is encircled by the two latitudinal rods and the two longitudinal rods; a clamper assembled on the assembling area, one end of the first spindle connected to one latitudinal rod which is adjacent to the transmitting wheel, another end of the first spindle inserted into the second rail, a rotation of the transmitting wheel driving the two latitudinal rods and the two longitudinal rods to swing transversely, via the first spindle which is connected between one latitudinal rod and the second rail of the transmitting wheel, the swing of each of the two latitudinal rods and the two longitudinal rods driving an opening of the clamper to open or close; a lift set having two positioning rods, two sliding blocks, a connecting plate and a second spindle, the two positioning rods assembled on the filling machine, the two positioning rods respectively and vertically located at two ends of the transmitting wheel, the connecting plate connecting the two sliding blocks, the two sliding blocks respectively mounted around the two positioning rods, each sliding block being axially movable relative to each corresponding positioning rod, the connecting plate extending across the transmitting wheel at one side of the transmitting wheel, one end of the second spindle connected to the connecting plate, another end of the second spindle inserted into the first rail; a supporting plate assembled to the two sliding blocks at one side of each sliding block, the supporting plate corresponding to the swing set, the supporting plate connected to the swing set, the second spindle moved along the first rail of the transmitting wheel, a motion of the second spindle driving each sliding block to axially move relative to each corresponding positioning rod via the connecting plate between the second spindle and each sliding block, a motion of each sliding block driving the supporting plate and the swing set to axially move, the supporting plate having a through opening corresponding to the opening of the clamper; and a transmitting set assembled to the filling machine and located below the supporting plate, the transmitting set having a third spindle, a transmitting band, a movable set and two roller rods, one end of each roller rod connected to the filling machine, the two roller rods spaced from each other, one end of the third spindle inserted into the third rail of the transmitting wheel, another end of the third spindle pivoted on the filling machine, the third spindle connected to one of the two sliding blocks, the movable set connected to the third spindle and located between the two roller rods, the transmitting band enclosing the two roller rods and the movable set, the third spindle moved along the third rail by the rotation of the transmitting wheel, a motion of the third spindle driving the movable set to axially move, the transmitting band axially moved by a motion of the movable set.

Wherein, the transmitting wheel further has a shaft bore opened therethrough; the shaft bore is located at a center of the transmitting wheel; the shaft bore is extended from the shaft member at one side of the transmitting wheel to another side of the transmitting wheel therethrough; the second rail has a tip portion defined thereon; a length of the first rail, a length of the second rail and a length of the third rail are different from each other; the movable set of the transmitting set further has a moving block, a moving base, a moving frame and a roller member; the moving frame is U-shaped; one end of the moving block is connected to the third spindle; another end of the moving block is horizontally extended toward a front direction relative to the filling machine; the moving base has an abutting portion and a supporting post; the abutting portion and the supporting post are connected to each other; the supporting post passes through another end of the moving block, so as to assemble the abutting portion on a top plane of the moving block; the moving frame has a horizontal plate and two vertical plates; the two vertical plates are respectively assembled at two ends of the horizontal plate; the horizontal plate of moving frame is assembled at a lower end of the supporting post; the roller member is pivoted between the two vertical plates; the transmitting band encloses the two roller rods, the abutting portion and the roller member; the third spindle is moved along the third rail by the rotation of the transmitting wheel; the motion of the third spindle drives the moving block, the moving base and the moving frame to upwardly or downwardly move; each sliding block has a supporting block extended toward the swing set; each sliding block is perpendicular to the supporting block extended therefrom; a middle block is assembled between the supporting block of each sliding block and the supporting plate; two sides of the middle block are respectively abutted against the supporting block of each sliding block and the supporting plate; an elastomer is mounted around another end of the third spindle; one end of the elastomer is fixed on the third spindle; another end of the elastomer abuts against an inner bottom of the filling machine; one latitudinal rod is connected to the first spindle; another latitudinal rod has a through hole opened thereon; a bolt passes through the through hole and is connected to the clamper.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of the present invention;

FIG. 2 is a perspective view for showing a structure of the present invention;

FIG. 3 is an exploded view of the present invention;

FIG. 4 is a perspective view for showing the structure of the present invention;

FIG. 5 is a perspective view for showing a transmitting wheel;

FIG. 6 is a perspective view for showing a transmitting wheel;

FIG. 7 is a front elevational view of the present invention which is not operated yet;

FIG. 8 is a front elevational view of the present invention which is being operated;

FIG. 9 is a rear elevational view of the present invention which is being operated;

FIG. 10 is a top plan view of the present invention, in which an opening of a clamper is opened;

FIG. 11 is a top plan view of the present invention, in which the opening of the clamper is closed;

FIG. 12 is a top plan view of the present invention, in which the opening of the clamper is opened again;

FIG. 13 is a front elevational view of the present invention, in which a lift set and a transmitting set are both operated;

FIG. 14 is a rear elevational view of the present invention, in which the lift set and the transmitting set are both operated;

FIG. 15 is a front elevational view of the present invention, in which an object is transmitted on the transmitting set when the transmitting set is downwardly moved; and

FIG. 16 is a front elevational view of the present invention, in which the object is transmitted on the transmitting set when the transmitting set is upwardly moved.

### DETAILED DESCRIPTION OF THE INVENTION

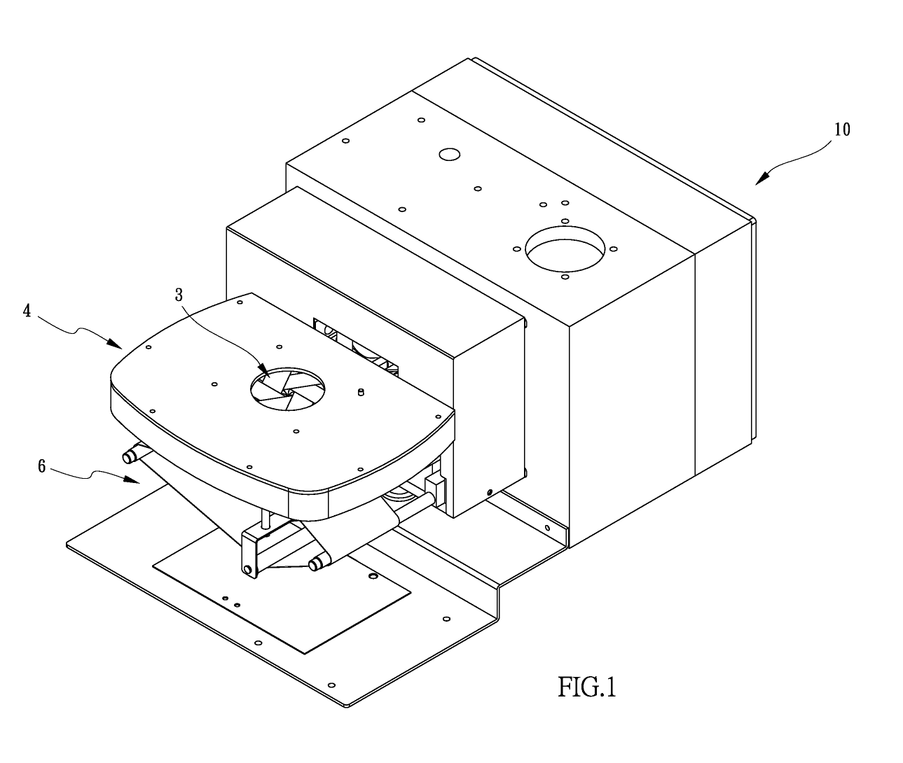

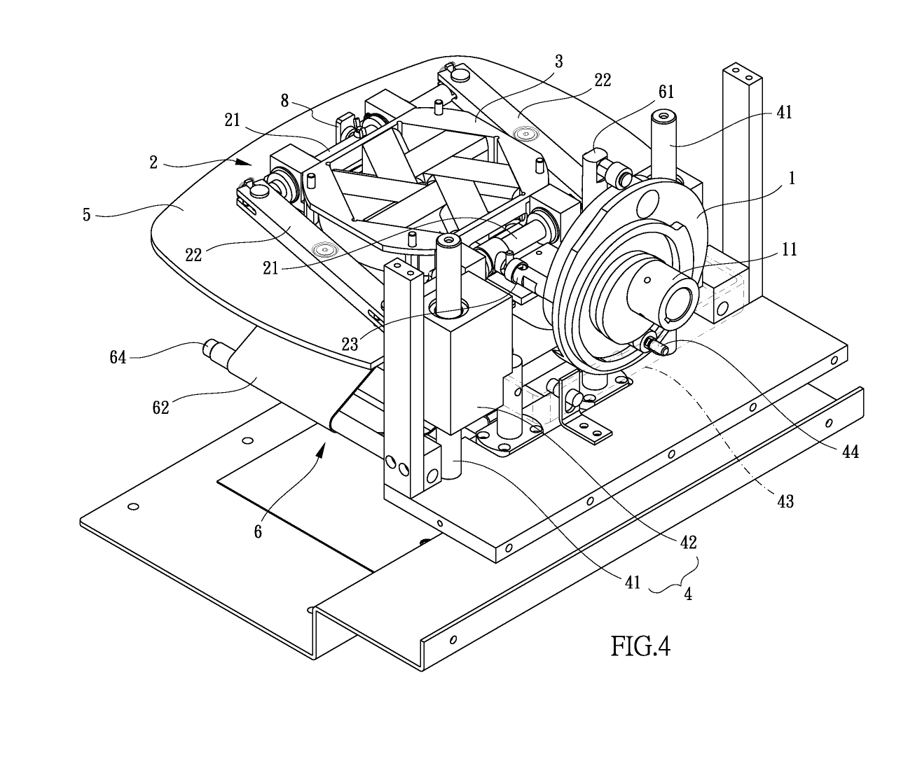

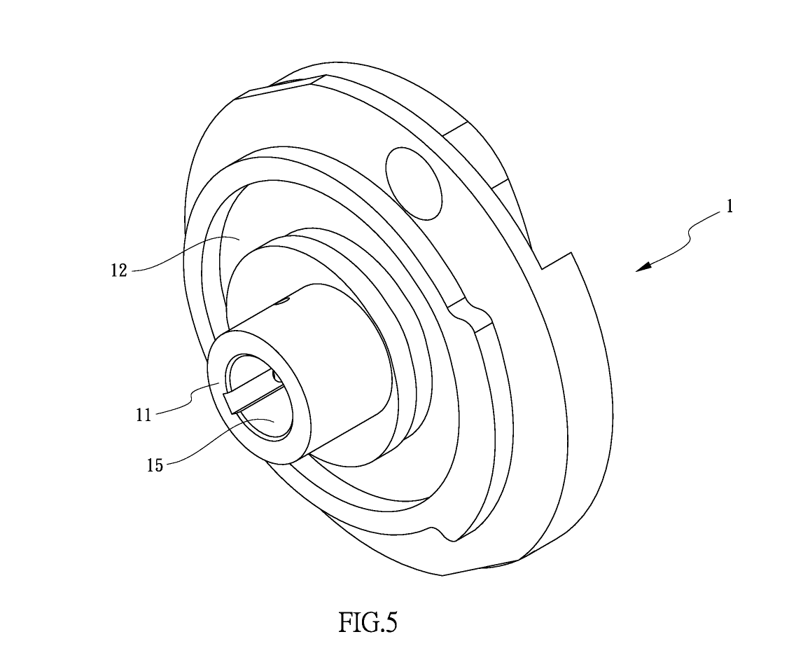

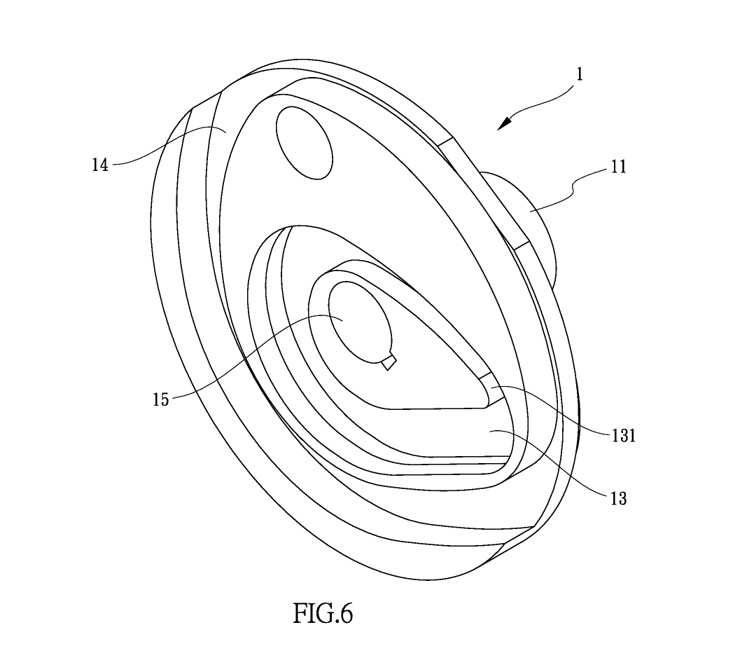

Referring to FIGS. 1-6, a transmission structure of a filling machine in accordance with the present invention is connected to a motor 101 of a filling machine 10, so as to drive a transmission operation of the filling machine 10. The transmission structure of a filling machine comprises a transmitting wheel 1, a swing set 2, a clamper 3, a lift set 4, a supporting plate 5 and a transmitting set 6. The transmitting wheel 1 has a shaft member 11 extended from one side thereof. The shaft member 11 is connected to the motor 101. The transmitting wheel 1 has a first rail 12 defined at one side thereof. The first rail 12 encircles the shaft member 11. The transmitting wheel 1 has a second rail 13 defined around a center of another side thereof. The transmitting wheel 1 has a third rail 14 defined at another side thereof. The third rail 14 is located along an outer periphery of the second rail 13. The third rail 14 has two ends which both communicate with an outside relative to the transmitting wheel 1. The swing set 2 is assembled to the transmitting wheel 1. The swing set 2 has two latitudinal rods 21, two longitudinal rods 22 and a first spindle 23. Each latitudinal rod 21 is connected to the two longitudinal rods 22 at two ends thereof, so as to define an assembling area 24 which is encircled by the two latitudinal rods 21 and the two longitudinal rods 22. The clamper 3 is assembled on the assembling area 24. One end of the first spindle 23 is connected to one latitudinal rod 21 which is adjacent to the transmitting wheel 1. Another end of the first spindle 23 is inserted into the second rail 13. A rotation of the transmitting wheel 1 drives the two latitudinal rods 21 and the two longitudinal rods 22 to swing transversely, via the first spindle 23 which is connected between one latitudinal rod 21 and the second rail 13 of the transmitting wheel 1. The swing of each of the two latitudinal rods 21 and the two longitudinal rods 22 drives an opening of the clamper 3 to open or close.

The lift set 4 has two positioning rods 41, two sliding blocks 42, a connecting plate 43 and a second spindle 44. The two positioning rods 41 are assembled on the filling machine 10. The two positioning rods 41 are respectively and vertically located at two ends of the transmitting wheel 1. The connecting plate 43 connects the two sliding blocks 42. The two sliding blocks 42 are respectively mounted around the two positioning rods 41. Each sliding block 42 is axially movable relative to each corresponding positioning rod 41. The connecting plate 43 extends across the transmitting wheel 1 at one side of the transmitting wheel 1. One end of the second spindle 44 is connected to the connecting plate 43. Another end of the second spindle 44 is inserted into the first rail 12. The supporting plate 5 is assembled to the two sliding blocks 42 at one side of each sliding block 42. The supporting plate 5 corresponds to the swing set 2. The supporting plate 5 is connected to the swing set 2. The supporting plate 5 has a through opening 51 corresponding to the opening of the clamper 3. The second spindle 44 is moved along the first rail 12 of the transmitting wheel 1. A motion of the second spindle 44 drives each sliding block 42 to axially move relative to each corresponding positioning rod 41 via the connecting plate 43 between the second spindle 44 and each sliding block 42. A motion of each sliding block 42 drives the supporting plate 5 and the swing set 2 to axially move.

The transmitting set 6 is assembled to the filling machine 10 and is located below the supporting plate 5. The transmitting set 6 has a third spindle 61, a transmitting band 62, a movable set 63 and two roller rods 64. One end of each roller rod 64 is connected to the filling machine 10. The two roller rods 64 are spaced from each other. One end of the third spindle 61 is inserted into the third rail 14 of the transmitting wheel 1. Another end of the third spindle 61 is pivoted on the filling machine 10. The third spindle 61 is connected to one of the two sliding blocks 42. The movable set 63 is connected to the third spindle 61 and is located between the two roller rods 64. The transmitting band 62 encloses the two roller rods 64 and the movable set 63. The third spindle 61 is moved along the third rail 14 by the rotation of the transmitting wheel 1. A motion of the third spindle 61 drives the movable set 63 to axially move. The transmitting band 62 is axially moved by a motion of the movable set 63. Under this arrangement, the first spindle 23, the second spindle 44 and the third spindle 61 are respectively moved along the second rail 13, the first rail 12 and the third rail 14, via the rotation of the transmitting wheel 1; as a result, the swing set 2, the lift set 4 and the transmitting set 6 are driven to operating by said motions of the spindles 23, 44 and 61. Therefore, objects which are under filling can be cut to be formed and be transmitted smoothly.

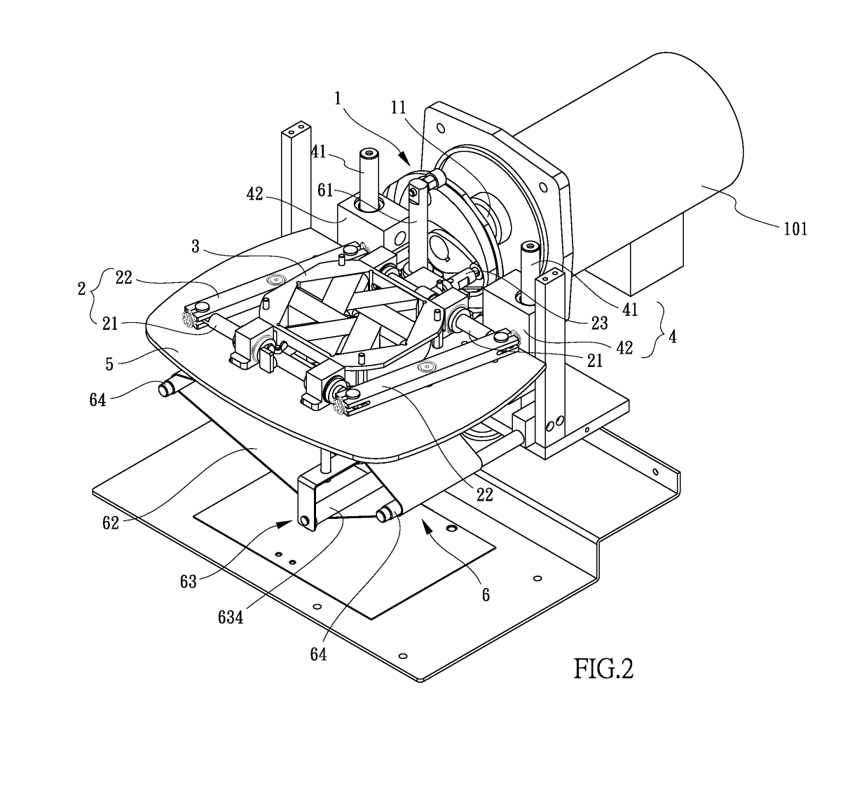

Referring to FIGS. 2 and 5-6, the transmitting wheel 1 further has a shaft bore 15 opened therethrough. The shaft bore 15 is located at a center of the transmitting wheel 1. The shaft bore 15 is extended from the shaft member 11 at one side of the transmitting wheel 1 to another side of the transmitting wheel 1 therethrough, so that the second rail 13 and the third rail 14 both surround the shaft bore 15. The motor 101 has a shaft (not shown). The transmitting wheel 1 is assembled on the motor 101 via the shaft bore 15 of the transmitting wheel 1 and the shaft of the motor 101.

The second rail 13 has a tip portion 131 defined thereon. A length of the first rail 12, a length of the second rail 13 and a length of the third rail 14 are different from each other. A track of the first rail 12, a track of the second rail 13 and a track of the third rail 14 are different from each other. When the transmitting wheel 1 rotates, the first spindle 23, the second spindle 44 and the third spindle 61 respectively drive the swing set 2, the lift set 4 and the transmitting set 6 to operate at different times, because said lengths or said tracks are different from each other. For example, when the first spindle 23 is moved along the second rail 13 and is pressed by the tip portion 131 of the second rail 13, a swing direction of the swing set 2 is shifted by a motion of the first spindle 23; in addition, the swing set 2, the lift set 4 and the transmitting set 6 cooperate with each other, so as to define a best sequence of cutting and transmitting and make products uniformly (as shown in FIGS. 2 and 5-6).

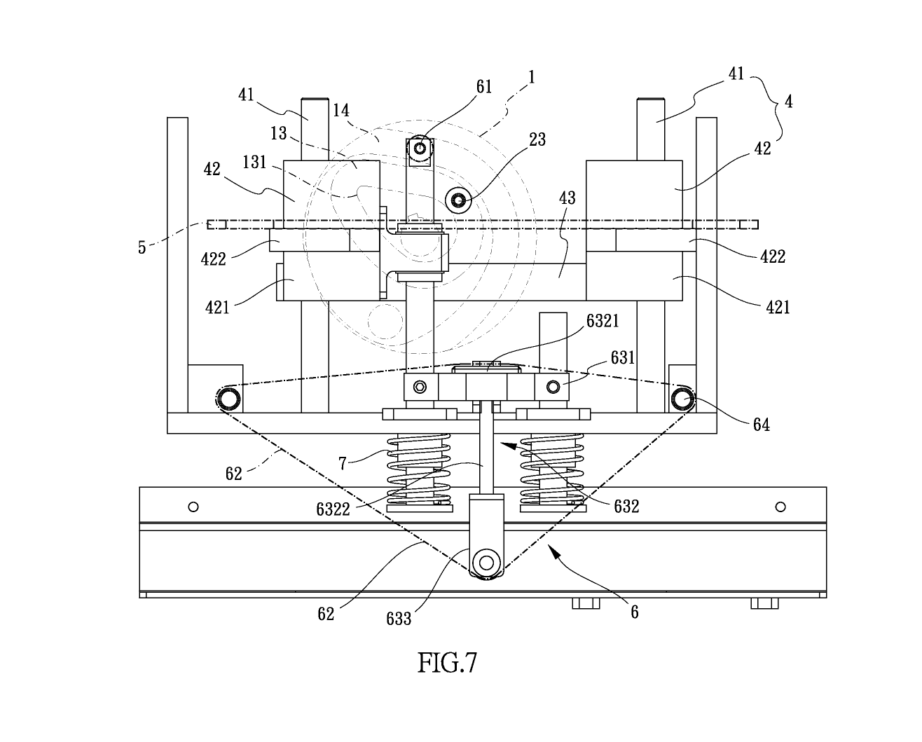

Each sliding block 42 has a supporting block 421 extended from one side thereof toward the swing set 2. Each sliding block 42 is perpendicular to the supporting block 421 extended therefrom. A middle block 422 is assembled between the supporting block 421 of each sliding block 42 and the supporting plate 5. Two sides of the middle block 422 are respectively abutted against the supporting block 421 of each sliding block 42 and the supporting plate 5. The middle block 422 of each sliding block 42 is configured to move the supporting plate 5 and the wing set 2 directly. In addition, a user can replace the middle block 422 of each sliding block 42 with another middle block which has a thickness being different from that of the middle block 422, so as to adjust a time slot of the axially motion of the lift set 4, the supporting plate 5 and the wing set 2 (as shown in FIGS. 2 and 7).

The movable set 63 of the transmitting set 6 further has a moving block 631, a moving base 632, a moving frame 633 and a roller member 634. The moving frame 633 is U-shaped. The moving block 631 is T-shaped. One end of the moving block 631 is connected to the third spindle 61. Another end of the moving block 631 is horizontally extended toward a front direction relative to the filling machine 10, and is assembled to the moving base 632. The moving base 632 has an abutting portion 6321 and a supporting post 6322. The abutting portion 6321 and the supporting post 6322 are vertically connected to each other. An upper end of the supporting post 6322 passes through another end of the moving block 631, so as to assemble the abutting portion 6321 on a top plane of the moving block 631. The moving frame 633 is assembled at a lower end of the supporting post 6322. The moving frame 633 has a horizontal plate 6331 and two vertical plates 6332. The two vertical plates 6332 are respectively assembled at two ends of the horizontal plate 6331. The two vertical plates 6332 are spaced from each other. The roller member 634 is pivoted between the two vertical plates 6332. The lower end of the supporting post 6322 passes through the horizontal plate 6331 of the moving frame 633. The transmitting band 62 encloses the two roller rods 64, the abutting portion 6321 and the roller member 634. The third spindle 61 is moved along the third rail 14 by the rotation of the transmitting wheel 1. The motion of the third spindle 61 drives the moving block 631, the moving base 632 and the moving frame 633 to upwardly or downwardly move. Under this arrangement, before one of the objects is cut, the motion of the third spindle 61 drives the moving block 631, the moving base 632 and the moving frame 633 to upwardly move; as a result, the transmitting band 62 is upwardly moved by a motion of the movable set 63, so as to hold the object. In contrast, after the object is cut, the motion of the third spindle 61 is shifted by the third rail 14 of the transmitting wheel 1 and drives the abutting portion 6321 and the moving frame 633 to downwardly move away from the swing set 2; as a result, the transmitting band 62 transmits the object forward, via a rotation of the roller member 634. Therefore, the objects are transmitted smoothly and are formed uniformly (as shown in FIGS. 2-3 and 7-8).

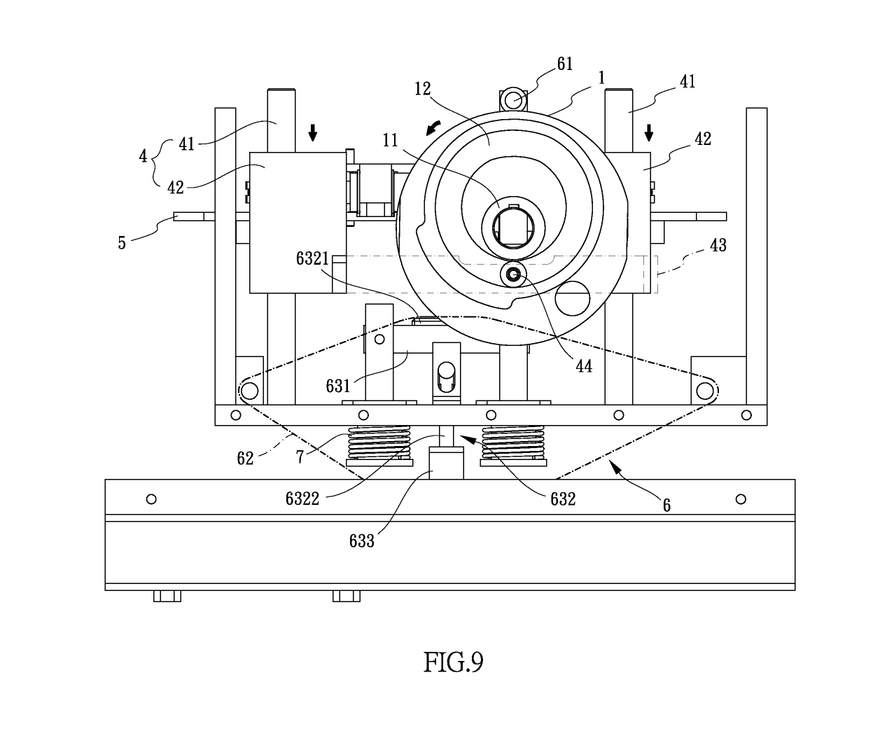

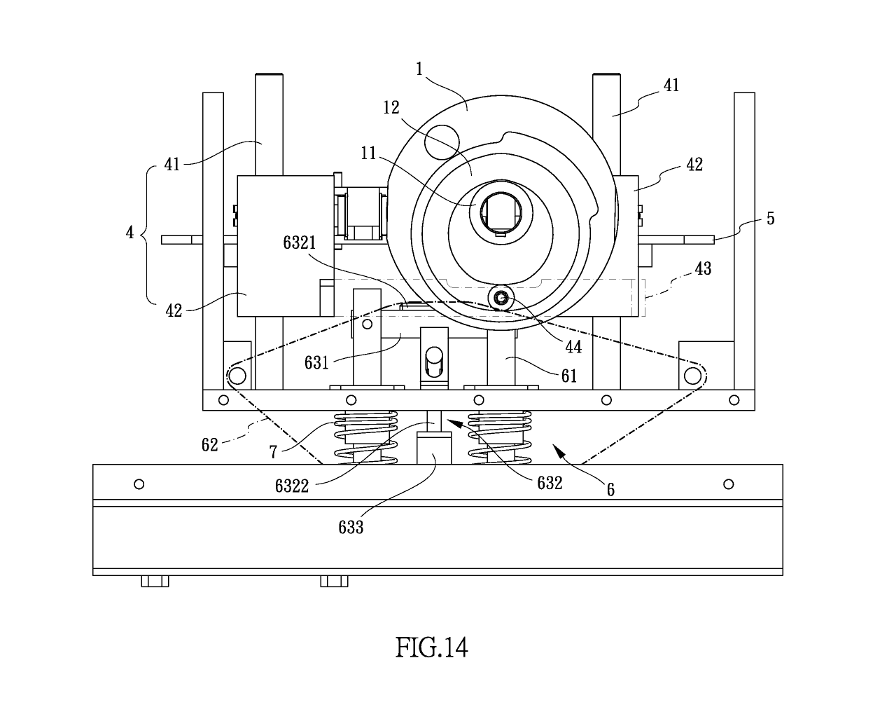

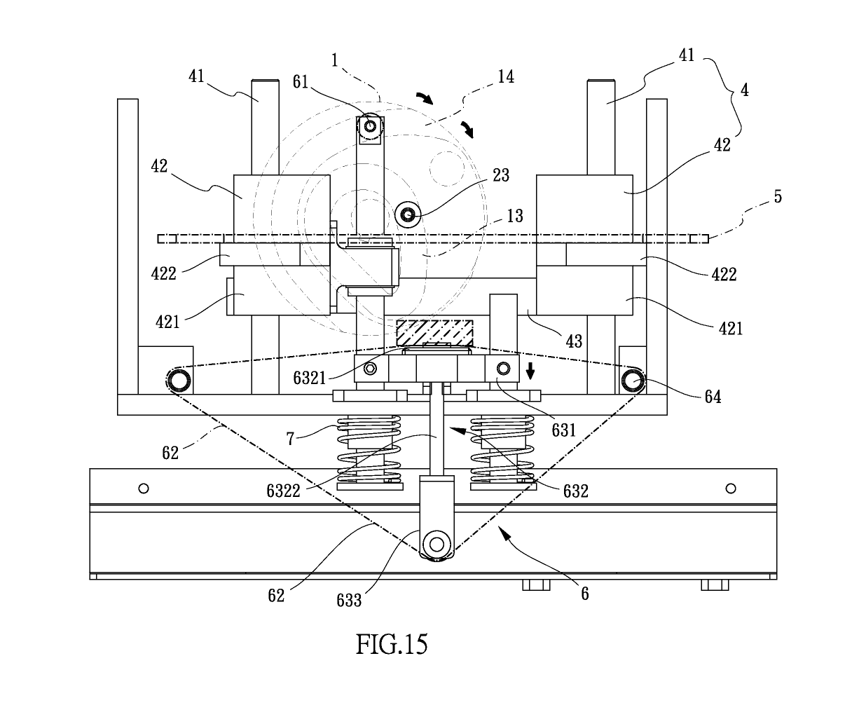

An elastomer 7 is mounted around another end of the third spindle 61. One end of the elastomer 7 is fixed on the third spindle 61. Another end of the elastomer 7 abuts against an inner bottom of the filling machine 10. The elastomer 7 is configured to make the axially motion of the third spindle 61 stable, so as to prevent the transmitting band 62 from being shaken by the axially motion of the third spindle 61 (as shown in FIGS. 7-9 and 12-16). Therefore, the objects are held and transmitted on the transmitting band 62 stably.

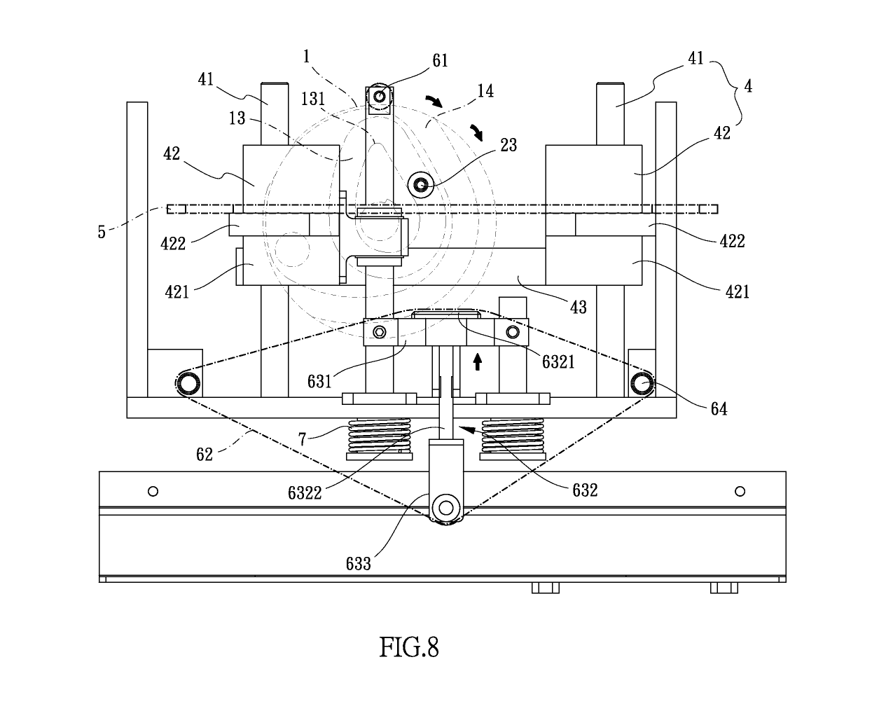

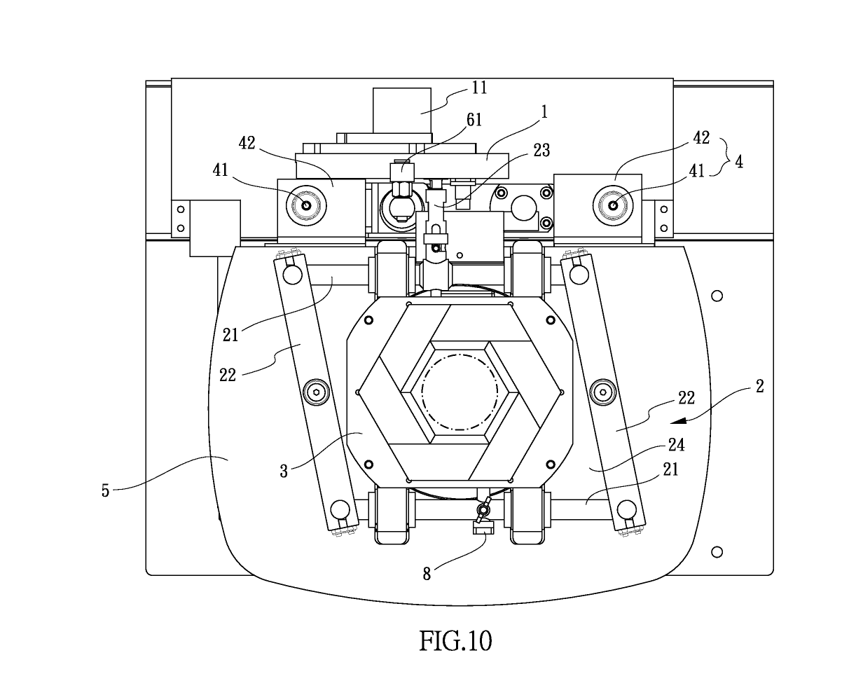

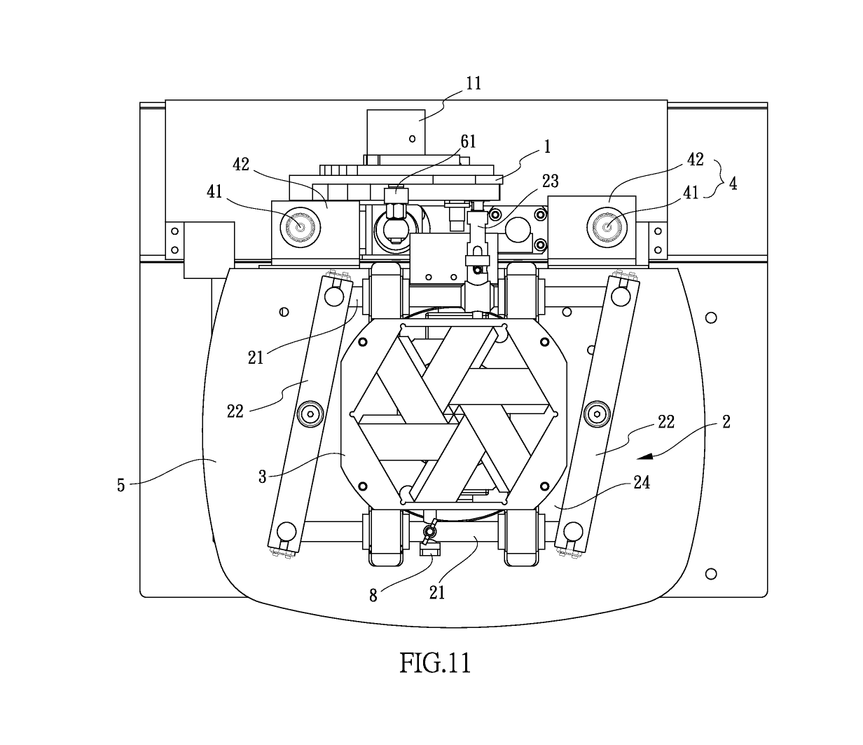

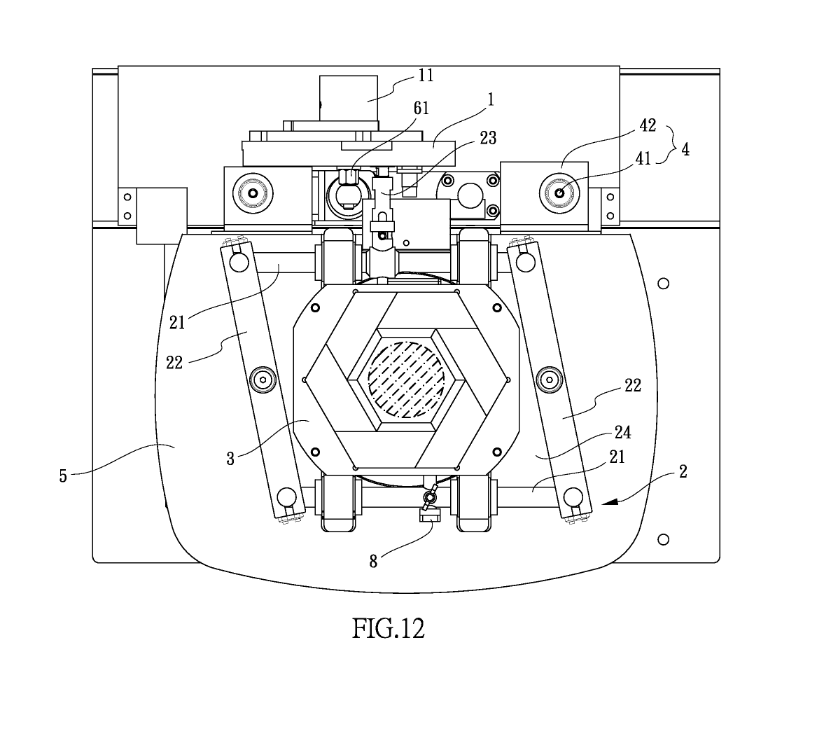

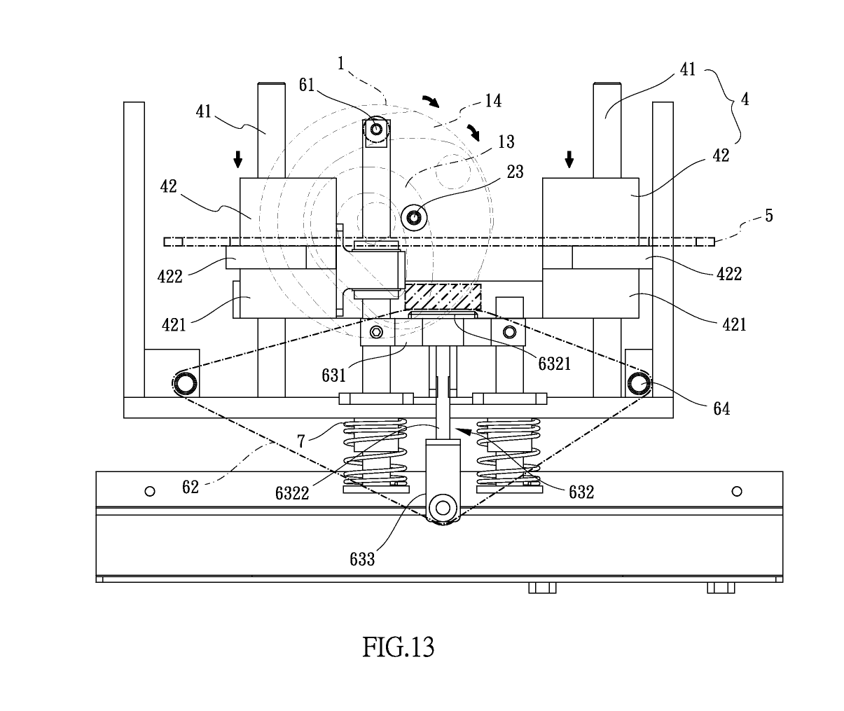

The detail of the operation of the present invention is further described as following. Before the present invention is operated, the opening of the clamper 3 is opened; the supporting plate 5 is located at an initial position; the movable set 63 of the transmitting set 6 does not yet drive the transmitting band 62 to upwardly move (as shown in FIGS. 7 and 10). When the motor 101 is operated and drives the transmitting wheel 1 to rotate, the third spindle 61 is moved along the third rail 14 and drives the abutting portion 6321 of the movable set 63 to upwardly move; the abutting portion 6321 moves the transmitting band 62 toward the supporting plate 5 and the swing set 2 (as shown in FIGS. 2 and 8); the first spindle 23 is moved along the second rail 13 and the second spindle 44 is moved along the first rail 12 via the rotation of the transmitting wheel 1; each sliding block 42 is downwardly moved relative to each corresponding positioning rods 41 via the connecting plate 43 connected each sliding block 42 and the second spindle 44; the supporting plate 5 and the swing set 2 are downwardly moved via the motion of each sliding block 42 (as shown in FIG. 13); the first spindle 23 is moved along the second rail 13 so as to drive the swing set 2 to swing transversely back and forth; the opening of the clamper 3 is opened and closed via the transverse swing of the swing set 2 (as shown in FIGS. 11-12). As a result, when the lift set 4 drives the supporting plate 5 to downwardly move, simultaneously the swing set 2 drives the opening of the clamper 3 to open and close repeatedly, so as to cut the object and transmit the cut object to the transmitting band 62 of the transmitting set 6 via the through opening 51 of the supporting plate 5 (as shown in FIGS. 7-15).

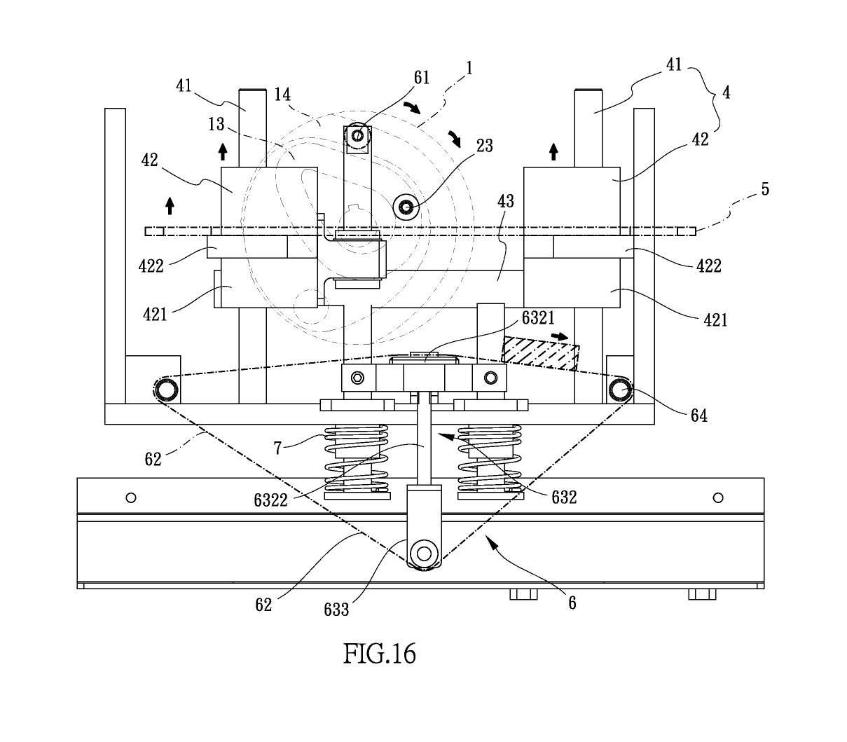

Thereafter, the transmitting wheel 1 continues rotating; the third spindle 61 is moved along the third rail 14 and drives the abutting portion 6321 of the movable set 63 to shift to downwardly move; the transmitting band 62 is released back from the supporting plate 5 and the swing set 2 via the motion of the abutting portion 6321 (as shown in FIG. 16), so as to transmit the object stably; the second spindle 44 is moved along the first rail 12; the supporting plate 5 and the swing set 2 shift to upwardly move via the motion of each sliding block 42, so that the present invention is back to an initial state.

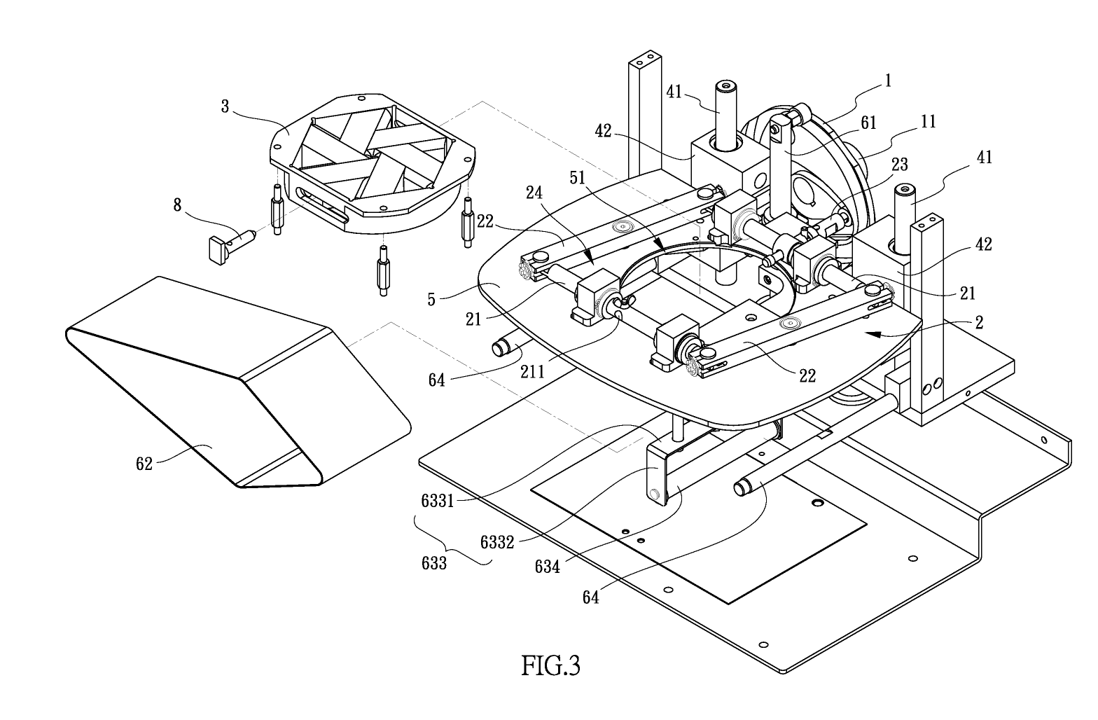

Furthermore, one latitudinal rod 21, which is adjacent to the transmitting wheel 1, is connected to the first spindle 23; another latitudinal rod 21 has a through hole 211 opened thereon; a bolt 8 passes through the through hole 211 and is connected to the clamper 3, so that the swing set 2 drives the opening of the clamper 3 to close when the swing set 2 swings left; the swing set 2 drives the opening of the clamper 3 to open when the swing set 2 swings right. Therefore, the opening of the clamper 3 opens and closes repeatedly and regularly via a structure of the transmitting wheel 1, so that all the cut objects have a uniform size (as shown in FIG. 3).

All in all, the swing set 2, the lift set 4 and the transmitting set 6 cooperate with each other via only the transmitting wheel 1, rather than cooperate with each other via a plurality of gears corresponding to different sets as the prior art. Therefore, the structure of the present invention is simpler than that of the prior art; a weight or a volume of the present invention is littler than that of the prior art. In addition, the present invention is easier to maintain than the prior art, because the structure of the present invention is simpler than that of the prior art. By the way, each of the spindles 23, 44 and 61 never unexpectedly derails from each of the rails 12, 13 and 14 during operation, because of the inventive design of the transmitting wheel 1.

Although the invention has been explained in relation to its preferred embodiment, it is to be understood that many other possible modifications and variations can be made without departing from the spirit and scope of the invention as hereinafter claimed.

What is claimed is:

1. A transmission structure, which is connected to a motor of a filling machine so as to drive a transmission operation of the filling machine, comprising:
a transmitting wheel having a shaft member extended from one side thereof, the shaft member connected to the motor, the transmitting wheel having a first rail defined at one side thereof, the first rail encircling the shaft member, the transmitting wheel having a second rail defined around a center of another side thereof, the transmitting wheel having a third rail defined at another side thereof, the third rail located along an outer periphery of the second rail, the third rail having two ends which both communicate with an outside relative to the transmitting wheel;
a swing set assembled to the transmitting wheel, the swing set having two latitudinal rods, two longitudinal rods and a first spindle, each latitudinal rod connected to the two longitudinal rods at two ends thereof, so as to define an assembling area which is encircled by the two latitudinal rods and the two longitudinal rods;
a clamper assembled on the assembling area, one end of the first spindle connected to one latitudinal rod which is adjacent to the transmitting wheel, another end of the first spindle inserted into the second rail, a rotation of the transmitting wheel driving the two latitudinal rods and the two longitudinal rods to swing transversely, via the first spindle which is connected between one latitudinal rod and the second rail of the transmitting wheel, the swing of each of the two latitudinal rods and the two longitudinal rods driving an opening of the clamper to open or close;
a lift set having two positioning rods, two sliding blocks, a connecting plate and a second spindle, the two positioning rods assembled on the filling machine, the two positioning rods respectively and vertically located at two ends of the transmitting wheel, the connecting plate connecting the two sliding blocks, the two sliding blocks respectively mounted around the two positioning rods, each sliding block being axially movable relative to each corresponding positioning rod, the connecting plate extending across the transmitting wheel at one side of the transmitting wheel, one end of the second spindle connected to the connecting plate, another end of the second spindle inserted into the first rail;
a supporting plate assembled to the two sliding blocks at one side of each sliding block, the supporting plate corresponding to the swing set, the supporting plate connected to the swing set, the second spindle moved along the first rail of the transmitting wheel, a motion of the second spindle driving each sliding block to axially move relative to each corresponding positioning rod via the connecting plate between the second spindle and each sliding block, a motion of each sliding block driving the supporting plate and the swing set to axially move, the supporting plate having a through opening corresponding to the opening of the clamper; and
a transmitting set assembled to the filling machine and located below the supporting plate, the transmitting set having a third spindle, a transmitting band, a movable set and two roller rods, one end of each roller rod connected to the filling machine, the two roller rods spaced from each other, one end of the third spindle inserted into the third rail of the transmitting wheel, another end of the third spindle pivoted on the filling machine, the third spindle connected to one of the two sliding blocks, the movable set connected to the third spindle and located between the two roller rods, the transmitting band enclosing the two roller rods and the movable set, the third spindle moved along the third rail by the rotation of the transmitting wheel, a motion of the third spindle driving the movable set to axially move, the transmitting band axially moved by a motion of the movable set.

2. The transmission structure as claimed in claim 1, wherein the transmitting wheel further has a shaft bore opened therethrough; the shaft bore is located at a center of the transmitting wheel; the shaft bore is extended from the shaft member at one side of the transmitting wheel to another side of the transmitting wheel therethrough.

3. The transmission structure as claimed in claim 2, wherein the second rail has a tip portion defined thereon; a length of the first rail, a length of the second rail and a length of the third rail are different from each other.

4. The transmission structure as claimed in claim 1, wherein the movable set of the transmitting set further has a moving block, a moving base, a moving frame and a roller member; the moving frame is U-shaped; one end of the moving block is connected to the third spindle; another end of the moving block is horizontally extended toward a front direction relative to the filling machine; the moving base has an abutting portion and a supporting post; the abutting portion and the supporting post are connected to each other; the supporting post passes through another end of the moving block, so as to assemble the abutting portion on a top plane of the moving block; the moving frame has a horizontal plate and two vertical plates; the two vertical plates are respectively assembled at two ends of the horizontal plate; the horizontal plate of moving frame is assembled at a lower end of the supporting post; the roller member is pivoted between the two vertical plates; the transmitting band encloses the two roller rods, the abutting portion and the roller member; the third spindle is moved along the third rail by the rotation of the transmitting wheel; the motion of the third spindle drives the moving block, the moving base and the moving frame to upwardly or downwardly move.

5. The transmission structure as claimed in claim 1, wherein each sliding block has a supporting block extended toward the swing set; each sliding block is perpendicular to the supporting block extended therefrom; a middle block is assembled between the supporting block of each sliding block and the supporting plate; two sides of the middle block are respectively abutted against the supporting block of each sliding block and the supporting plate.

6. The transmission structure as claimed in claim 1, wherein an elastomer is mounted around another end of the third spindle; one end of the elastomer is fixed on the third spindle; another end of the elastomer abuts against an inner bottom of the filling machine.

7. The transmission structure as claimed in claim 1, wherein one latitudinal rod is connected to the first spindle; another latitudinal rod has a through hole opened thereon; a bolt passes through the through hole and is connected to the clamper.
